(19) United States
(12) Patent Application Publication
(10) Pub. No.: US 2010/0141159 A1
(43) Pub. Date: Jun. 10, 2010

(54) LED DRIVING CIRCUIT AND CONTROLLER WITH TEMPERATURE COMPENSATION THEREOF

(75) Inventors: Shian-Sung Shiu, Taipei County (TW); Li-Min Lee, Taipei County (TW); Chung-Che Yu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Green Solution Technology Inc., Taipei County (TW)

(21) Appl. No.: 12/399,017

(22) Filed: Mar. 6, 2009

(30) Foreign Application Priority Data
Dec. 8, 2008 (TW) 97147574

(51) Int. Cl. H05B 37/02

(52) U.S. Cl. 315/185 R; 315/309

(57) ABSTRACT

The present invention provides an LED driving circuit with temperature compensation, comprising a power transforming circuit, an LED module and a controller. The transforming circuit receives an electrical power from an input power source and transforms it into an output voltage according to a control signal. The LED module is coupled to the transforming circuit. The controller generates the control signal according to an operation temperature and a voltage feedback signal indicative of the output voltage, and makes the output voltage decrease with increasing operation temperature. Therefore, the LED driving circuit of the present invention has an effect of temperature compensation that compensates the influence of the decreased driving voltage of the LED module due to temperature.

### CROSS-REFERENCE TO RELATED APPLICATION

This application claims the priority benefit of Taiwan application serial no. 97147574, filed on Dec. 8, 2008. The entirety of the above-mentioned patent application is hereby incorporated by reference herein and made a part of specification.

### BACKGROUND OF THE INVENTION

1. Field of the Invention

The present invention is related to an LED driving circuit and controller; and in particular, to a LED driving circuit and controller with temperature compensation thereof.

2. Description of Related Art

Referring to FIG. 1, which shows an LED driving apparatus in conventional arts. The LED driving apparatus comprises a current equalizer 10, a voltage transforming circuit 20, an LED module 30 and a voltage detector 40. The voltage transforming circuit 20 is coupled to an input power source Vin and transfers it into an output voltage Vout. The LED module 30 is coupled between the voltage transforming circuit 20 and the current equalizer 10 and driven by the output voltage Vout. The current equalizer 10 have a plurality of terminals being respectively connected to LED strings of the LED module 30 to equalize the currents passing through the LED strings for balancing the lighting. Moreover, the current passing through the LED module could be set by a current setting resistor R, connected between the current equalizer 10 and a constant voltage source Vcc, and so the LED module 30 might light stably regardless to the output voltage Vout. The voltage detector 40 is a divider and generates a voltage feedback signal Vf according to the output voltage Vout. The voltage transforming circuit 20 modulates the output voltage Vout according to the voltage feedback signal Vf so as to stably the output voltage Vout around a preset voltage. The output voltage Vout is designed to being slight higher than a driving voltage for the LED module 30 and the current equalizer 10 takes a difference voltage between the output voltage Vout and the driving voltage. Hence, an efficiency of the LED driving apparatus is determined by the difference voltage, i.e.: more high difference voltage, more low efficiency.

Referring to FIG. 2, which shows a curve of threshold voltage (Vth)-temperature. The threshold voltage Vth of LED decreases with increasing operation temperature. Therefore, the required driving voltage for the LED module 30 decreases with increasing operation temperature. However, the output voltage Vout is constant due to that the voltage transforming circuit 20 is controlled under constant-voltage control, and so the output voltage Vout could not vary according to the temperature. It results that the voltage difference between the driving voltage and the output voltage Vout increases with increasing temperature, and furthermore the efficiency of the driving apparatus lower

### SUMMARY OF THE INVENTION

In view of the problems in conventional arts, the LED driving apparatus and controller of the present invention have a function of temperature compensation, such that the output voltage is decreased with increasing operation temperature. Hence, the LED driving apparatus of the present invention could maintain the efficiency high within a wide operation temperature range.

To achieve the aforementioned objectives, the present invention provides an LED driving circuit with temperature compensation, comprising a power transforming circuit, an LED module, and a controller. The power transforming circuit receives an electrical power from an input power source and transforms the electrical power into an output voltage according to a control signal. The LED module is coupled to the power transforming circuit. The controller generates the control signal according to an operation temperature and a voltage feedback signal indicative of the output voltage, and so the output voltage is decreased with increasing operation temperature.

The present invention also provides a controller with temperature compensation, comprising a feedback circuit and a pulse width modulator. The feedback circuit generates an amplified error signal according to a voltage feedback signal and a reference voltage, wherein a temperature coefficient of the reference voltage is positive or negative within a preset range of operation temperature. The pulse width modulator generates a control signal according to the amplified error signal.

Compared with the conventional arts, the LED driving circuit and the controller of the present invention have the function of temperature compensation and control the output voltage generated by the power transforming circuit deceasing with increasing operation temperature for compensating that the required driving voltage e of the LED module deceases with increasing temperature. Hence, the LED driving apparatus of the present invention could maintain the efficiency high.

The Summary illustrated supra and subsequent Detailed Descriptions set out infra are both for further explaining the scope of the present invention. Other objectives and advantages relating to the present invention will be construed as well in the following texts and appended drawings.

### BRIEF DESCRIPTION OF THE DRAWINGS

FIG. 1 shows an LED driving apparatus in conventional arts.

FIG. 2 shows a curve of threshold voltage (Vth)-temperature.

FIG. 3 is a circuit block diagram of an LED driving apparatus according to the present invention.

FIG. 4 is a circuit diagram of a first preferred embodiment of the LED driving apparatus according to the present invention.

FIG. 5 is a circuit diagram of a second preferred embodiment of the LED driving apparatus according to the present invention.

FIG. 6 is a circuit diagram of a third preferred embodiment of the LED driving apparatus according to the present invention.

FIG. 7 is a circuit diagram of a fourth preferred embodiment of the LED driving apparatus according to the present invention.

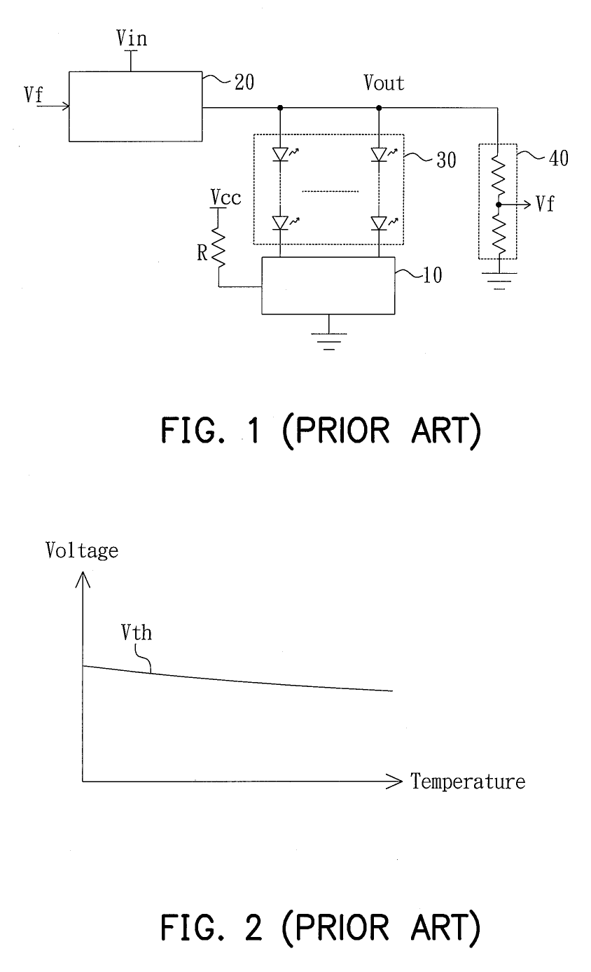

### DETAILED DESCRIPTION OF THE PREFERRED EMBODIMENTS

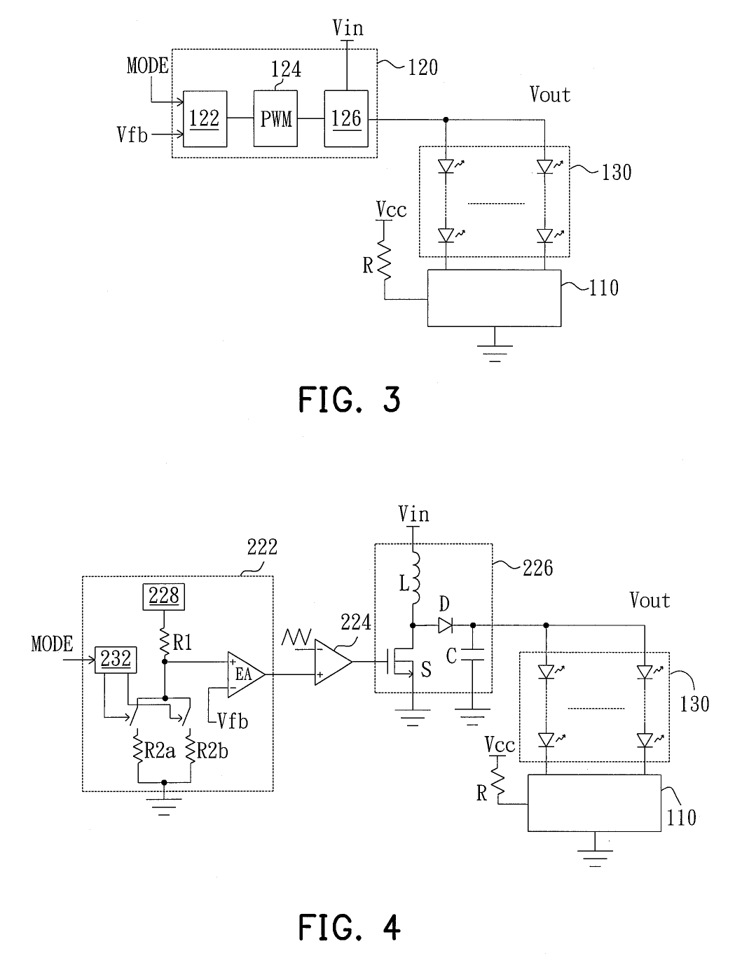

Please referring to FIG. 3, it is a circuit block diagram of an LED driving apparatus according to the present invention. The LED driving apparatus comprises a current balancing circuit 110, a power transforming circuit 120, and an LED module 130. The power transforming circuit 120 comprises a feedback circuit 122, a pulse width modulator 124, and a transforming circuit 126 (e.g.: an AC/DC converter or a DC/DC converter). The power transforming circuit 120 receives an electrical power from an input power source Vin and transforms it into an output voltage Vout according to a control signal. The controller comprises a feedback circuit 122 and a pulse width modulator 124. The feedback circuit 122 receives a voltage feedback signal Vfb indicative of the output voltage Vout and generates an amplified error signal accordingly, wherein the feedback circuit 122 has a function of negative temperature compensation to adjust the level of the amplified error signal according to the operation temperature. For example: in general, the voltage feedback signal Vfb is generated by a voltage divider (not shown), as a voltage detector, which is coupled to the output voltage Vout. The voltage detector has a negative temperature coefficient and so the feedback circuit 122 also has a function of negative temperature compensation. The pulse width modulator 124 generates the control signal according to the amplified error signal to control a level of the output voltage Vout generated by the transforming circuit 126. The LED module 130 is coupled to the transforming circuit 126 and is driven by the output voltage Vout to light. The current balancing circuit 110 is coupled to the LED module 130 to balance currents flowing through LED strings in the LED module 130, and so the currents flowing through the LED strings are substantially equal and the LED strings could light equally. In general, the current balancing circuit 110 is a current mirror and the current thereof is setup by a current setting resistor connected to a constant voltage power source Vcc. If the LED module 130 is a single LED string, the current balancing circuit 110 might be omitted. Due to the function of temperature compensation of the feedback circuit 122, the output voltage Vout also has a temperature coefficient, i.e.: the output voltage Vout deceases with the operation temperature increasing. Therefore, the LED driving apparatus according to the present invention can compensates the variation of the driving voltage of the LED module 130 due to temperature. Driving voltages in different LED modules may has different temperature coefficients and so the temperature coefficient of the feedback circuit 122 could be selected according to a mode selecting signal MODE for different application conditions.

Please refer to FIG. 4, it a circuit diagram of a first preferred embodiment of the LED driving apparatus according to the present invention. The LED driving apparatus comprises a current balancing circuit 110, an LED module 130, a controller having a feedback circuit 222 and a pulse width modulator 224, and a transforming circuit 226. The transforming circuit 226 is a DC/DC converter, comprising an inductor L, a rectifying diode D, an output capacitor C, and a transistor switch S, transforms the input power source Vin into an output voltage Vout according to a control signal generated by the controller to drive the LED module 130 lighting. The feedback circuit 222 comprises an error amplifier EA, a reference voltage generator 228 and a mode selector 232. The reference voltage generator 228 generates a reference voltage to input into a non-inverting terminal of the error amplifier EA via a voltage divider, and an inverting terminal of the error amplifier EA receives a voltage feedback signal Vf indicative of the output voltage Vout. Accordingly, the error amplifier EA outputs an amplified error signal. The voltage divider consists of resistors R1, R2a, R2b, wherein the resistor R2a and the resistor R2b have different negative temperature coefficients. Therefore, the voltages generated by the resistors R1, R2a or the resistors R1, R2b have different temperature coefficients. The mode selector 232 receives a mod selecting signal MODE to control switches, respectively between the resistors R1, R2a and between the resistors R1, R2b, to turn on/off for providing different temperature compensations. The pulse width modulator 224 is a comparator in which a non-inverting terminal thereof receives the amplified error signal and an inverting terminal thereof receives a ramp signal, and generates the control signal to control the transistor switch S of the transforming circuit 226.

Consequently, when the operation temperature is stable, the LED driving apparatus of the present invention outputs a stable output voltage as that of the conventional arts. Besides, the LED driving apparatus of the present invention could compensate the temperature effect in the driving voltage of the LED module when the operation temperature varying. Compared with the LED driving apparatus of the conventional arts, the LED driving apparatus according to the present invention can maintain efficiency high at the operation temperature range.

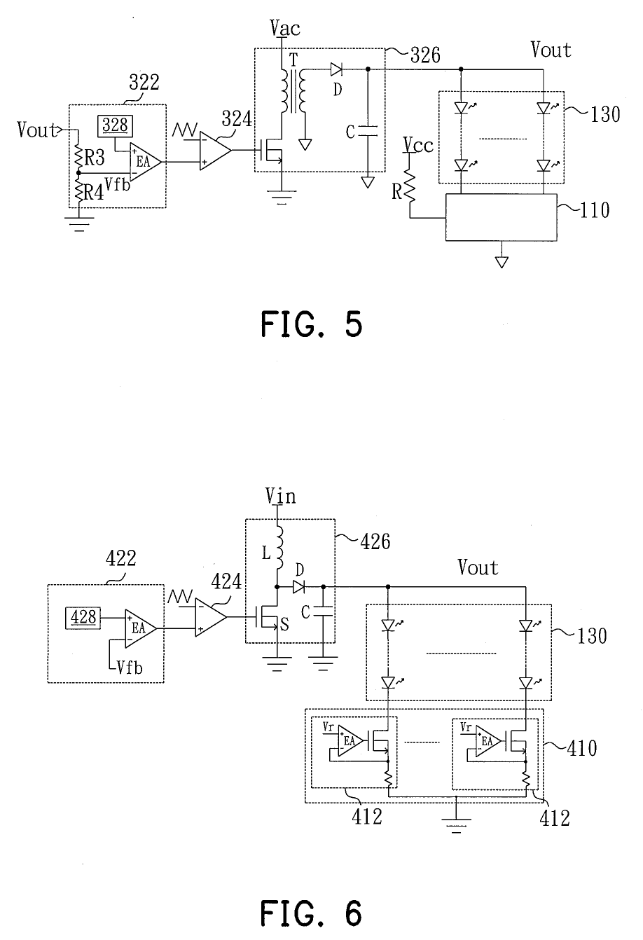

In addition to the reference voltage with negative temperature coefficient, the present invention uses a voltage detecting circuit with a positive temperature coefficient to execute the function of temperature compensation. Moreover, the transforming circuit might be an AC/DC converter in the present invention. Please refer to FIG. 5, it a circuit diagram of a second preferred embodiment of the LED driving apparatus according to the present invention. Compared with the LED driving apparatus shown in FIG. 4, a transforming circuit 326 is an AC/DC converter, replacing the DC/DC converter in FIG. 4, and the voltage detecting circuit of the feedback circuit 322 executes the function of temperature compensation. The transforming circuit 326 is a flyback AC/DC converter, comprising a transformer T, a transistor switch S, and an output capacitor C. In practice, the transforming circuit 326 could be any type AC/DC converter, such as half-bridge, full-bridge, forward, flyback and so on. The transforming circuit 326 receives an AC input signal Vac and transforms it into an output voltage Vout according to a control signal generated by a pulse width modulator 324. A feedback circuit 322 comprises an error amplifier EA and a reference voltage generator 328. A non-inverting terminal of the feedback circuit 322 receives a reference voltage signal generated by a reference voltage generator 328, an inverting terminal thereof receives a voltage feedback signal Vfb indicative of the output voltage Vout, and the feedback circuit 322 generates an amplified error signal accordingly. The voltage feedback signal Vfb is generated by a voltage detecting circuit coupled to the output voltage Vout, which comprises resistors R3, R4. A non-inverting terminal of the pulse width modulator 324 receives the amplified error signal, an inverting terminal thereof receives a ramp signal, and the pulse width modulator 324 generates the control signal accordingly to control the transistor switch S of the transforming circuit 326. Wherein, the resistor R3 of the voltage detecting circuit has a negative temperature coefficient or the resistor R4 of the voltage detecting circuit has a positive temperature coefficient, and so the voltage detecting circuit has a positive temperature coefficient to achieve the function of temperature compensation via negative feedback loop.

The current balancing circuit 110 in the aforementioned embodiments could be a current mirror for balancing current. The voltages at gate and source of the main transistor switch of the current mirror are the same, i.e.: the main transistor switch is operated in saturation region. Therefore, other transistor switches of the current mirror have to been operated in saturation region to ensure that each transistor switch is flowed with the same current and so the difference voltages between sources and drains of other transistor switches are large. The large difference voltage affects the efficiency of the LED driving apparatus. Please refer to FIG. 6, it a circuit diagram of a third preferred embodiment of the LED driving apparatus according to the present invention, wherein the main difference is that the current balancing circuit 410 comprises a plurality of constant-current sources 412 to replace the original current mirror. Each constant-current source 412 of the current balancing circuit 410 comprises a transistor switch, a resistor and an error amplifier EA. A first terminal of the transistor switch in the constant-current sources 412 is coupled to the corresponding LED strings of the LED module 130, a second terminal thereof is coupled to the resistor for generating a current detecting signal. A inverting terminal of the error amplifier EA in the constant-current source 412 receives the current detecting signal, an non-inverting terminal thereof receives a reference signal Vr, and an output terminal thereof outputs a constant current control signal to the transistor switch in the constant-current source 412 for controlling the current flowing through the transistor switch. Due to the reference signal Vr to the constant-current sources 412 is the same, the currents through the constant-current sources 412 are substantially equal. Furthermore, in the constant-current source 412, the voltage level of the drain of the transistor switch does not need to be equal or higher than the voltage level of the gate thereof, and so the difference voltage between the drain and source of the transistor switch in the constant-current source 412 is lower than that in current mirror. Hence, the power consumption of the current balancing circuit 410 according to the present invention is lower than that of the conventional current balancing circuit. Moreover, the reference voltage generator in the conventional arts is designed to be independent of temperature for generating a temperature-independent voltage signal. Alternatively, the reference voltage signal generated by the reference voltage generator in the conventional arts could have positive temperature coefficient in partial temperature range of the total operation temperature range and negative temperature coefficient in other temperature range thereof; however the level of reference voltage signal in total operation temperature always be around a preset level. In the embodiment, the reference voltage generator 428 of the feedback circuit 422 has a negative temperature coefficient in total operation temperature range.

The feedback circuit 422 receives a reference voltage signal with negative temperature coefficient and a voltage feedback signal Vfb indicative of the output voltage Vout to generate the amplified error signal. The pulse width modulator 424 receives the amplified error signal and a ramp signal to accordingly generate a control signal for controlling the transistor switch S of the transforming circuit 426. Therefore, the controller of the embodiment has a function of negative temperature compensation and also could compensate the temperature effect on the driving voltage of the LED module 130.

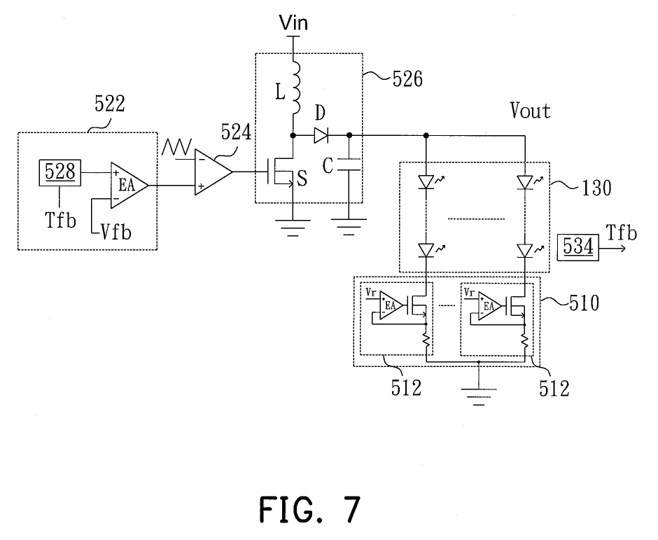

Besides, the operation temperature mentioned above means the operation temperature of the controller, and the operation temperature controller has a position correlation with the operation temperature of the LED module, and so the operation temperature of the controller could replace the operation temperature of the LED module to use to compensate the temperature effect on the driving voltage. Of course, in practice, the present invention could directly detect the operation temperature of the LED module and accordingly compensate the temperature effect on the driving voltage for achieve more accurate temperature compensation. Please refer to FIG. 7, it a circuit diagram of a fourth preferred embodiment of the LED driving apparatus according to the present invention. Compared with the embodiment shown in FIG. 6, the embodiment more comprises a temperature detector 534. A reference voltage generator 528 modulates the level of a reference voltage signal according to a temperature feedback signal Tfb generated by the temperature detector 534 and so the reference voltage signal ahs a temperature coefficient. A feedback circuit 522 receives the reference voltage signal with negative temperature coefficient and a voltage feedback signal Vfb indicative of an output voltage Vout, and accordingly generates an amplified error signal. A pulse width modulator 524 receives the amplified error signal and a ramp signal, and accordingly generates a control signal to control a transistor switch S of a transforming circuit 526.

Although the embodiments mentioned above takes a voltage generator with negative temperature coefficient or a voltage detecting circuit with positive temperature coefficient for example, a voltage generator with positive temperature coefficient or a voltage detecting circuit with negative temperature coefficient can also be applied to the present invention according to the different circuit design to achieve temperature compensation.

As described above, the present invention completely fulfills the three requirements on patent application: innovation, advancement and industrial usability. In the aforementioned texts the present invention has been disclosed by means of preferred embodiments thereof; however, those skilled in the art can appreciate that these embodiments are simply for the illustration of the present invention, but not to be interpreted as for limiting the scope of the present invention. It is noted that all effectively equivalent changes or modifications on these embodiments should be deemed as encompassed by the scope of the present invention. Therefore, the scope of the present invention to be legally protected should be delineated by the subsequent claims.

What is claimed is:

1. A LED driving circuit with temperature compensation comprising:
a power transforming circuit receiving an electrical power from an input power source and transforming the electrical power into an output voltage according to a control signal;
a LED module coupled to the power transforming circuit; and
a controller generating the control signal according to an operation temperature and a voltage feedback signal indicative of the output voltage, and so the output voltage is decreased with increasing operation temperature.

2. The LED driving circuit according to claim 1, wherein the controller comprises a feedback circuit and a pulse width modulator, the feedback circuit generates an amplified error signal according to the voltage feedback signal and a reference voltage, and the pulse width modulator generates the control signal according to the amplified error signal, wherein the reference voltage has a temperature coefficient and increases or decreases with varying the operation temperature.

3. The LED driving circuit according to claim 2, wherein the temperature coefficient is negative.

4. The LED driving circuit according to claim 3, wherein the reference voltage is generated by a reference voltage generator through a voltage divider with a negative temperature coefficient.

5. The LED driving circuit according to claim 4, wherein the negative temperature coefficient of the voltage divider is selected according to a mode selecting signal.

6. The LED driving circuit according to claim 2, further comprising a current balancing circuit coupled to the LED module to balancing currents flowing through LED strings of the LED module.

7. The LED driving circuit according to claim 6, wherein the current balancing circuit comprises a plurality of constant-current sources, each of which comprises a transistor switch, a resistor and an error amplifier, wherein a first terminal of the transistor switch is coupled to a corresponding LED string, a second terminal of the transistor switch is coupled to the resistor to generate a current detecting signal, a first input terminal of the error amplifier receives the current detecting signal, a second input terminal of the error amplifier receives a reference signal, and a output terminal of the error amplifier generates a constant-current control signal to the transistor switch for controlling the current flowing through the transistor switch.

8. The LED driving circuit according to claim 1, wherein the controller comprises a feedback circuit and a pulse width modulator, the feedback circuit generates an amplified error signal according to the voltage feedback signal and a reference voltage, and the pulse width modulator generates the control signal according to the amplified error signal, wherein the voltage feedback signal is generated by a voltage detector with a temperature coefficient according to the output voltage.

9. The LED driving circuit according to claim 8, further comprising a current balancing circuit coupled to the LED module to balancing currents flowing through LED strings of the LED module.

10. The LED driving circuit according to claim 9, wherein the current balancing circuit comprises a plurality of constant-current sources, each of which comprises a transistor switch, a resistor and an error amplifier, wherein a first terminal of the transistor switch is coupled to a corresponding LED string, a second terminal of the transistor switch is coupled to the resistor to generate a current detecting signal, a first input terminal of the error amplifier receives the current detecting signal, a second input terminal of the error amplifier receives a reference signal, and a output terminal of the error amplifier generates a constant-current control signal to the transistor switch for controlling the current flowing through the transistor switch.

11. The LED driving circuit according to claim 8, wherein the temperature coefficient is positive.

12. The LED driving circuit according to claim 8, wherein the power transforming circuit is an AC/DC converter or a DC/DC converter.

13. A controller with temperature compensation comprising:
a feedback circuit generating an amplified error signal according to a voltage feedback signal and a reference voltage, wherein a temperature coefficient of the reference voltage is positive or negative within a preset range of operation temperature; and
a pulse width modulator generating a control signal according to the amplified error signal.

14. The controller according to claim 13, wherein the reference voltage is generated by a reference voltage generator through a voltage divider with a temperature coefficient.

15. The controller according to claim 14, wherein the voltage divider comprises a first resistor and a second resistor, a end of the first resistor is coupled to the reference voltage generator, the other end of the first resistor is coupled to a end of the second resistor, and the other end of the second resistor is coupled to a common level, wherein the first resistor has a positive temperature coefficient or the second resistor has a negative temperature coefficient within a preset operation temperature.

16. The controller according to claim 14, wherein the temperature coefficient of the voltage divider is selected according to a mode selecting signal.
